(19) United States
(12) Patent Application Publication
(10) Pub. No.: US 2019/0171093 A1
(43) Pub. Date: Jun. 6, 2019

(54) WAVELENGTH CONVERSION MEMBER, LIGHT-EMITTING DEVICE, AND METHOD FOR MANUFACTURING WAVELENGTH CONVERSION MEMBER

(71) Applicant: NIPPON ELECTRIC GLASS CO., LTD., Otsu-shi, Shiga (JP)

(72) Inventors: Tadahito FURUYAMA, Otsu-shi (JP); Shunsuke FUJITA, Otsu-shi (JP)

(21) Appl. No.: 16/325,195

(22) PCT Filed: Sep. 20, 2017
(86) PCT No.: PCT/JP2017/033877

§ 371 Date: Feb. 13, 2019

(30) Foreign Application Priority Data
Oct. 21, 2016 (JP) 2016-206632

(51) Int. Cl. G03B 21/20; G02B 1/118; C03B 19/06

(52) U.S. Cl. CPC G03B 21/204; C03B 19/06; G02B 1/118

(57) ABSTRACT

Provided is a wavelength conversion member that can exhibit an antireflection function for incident light and emitted light at various angles and can increase the luminous efficiency. A wavelength conversion member 10 includes: a phosphor layer 1 containing a glass matrix 3 and phosphor particles 4 dispersed in the glass matrix 3; and a low-refractive index layer 2 formed on a surface of the phosphor layer 1 and having a refractive index equal to or smaller than a refractive index of the phosphor particles 4, wherein the low-refractive index layer 2 has an uneven surface structure and a waviness profile formed by the uneven surface structure has a root-mean-square gradient WΔq of 0.1 to 1.

### TECHNICAL FIELD

The present invention relates to wavelength conversion members for use in light-emitting devices, such as projectors.

### BACKGROUND ART

To reduce projector size, there have recently been proposed light-emitting devices in which a light source, such as an LED (light emitting diode) or an LD (laser diode), and a phosphor are used. For example, Patent Literature 1 discloses a projector in which a light-emitting device is used that includes a light source for emitting ultraviolet light and a wavelength conversion member for converting the ultraviolet light from the light source to visible light. The wavelength conversion member used in Patent Literature 1 is a wavelength conversion member (fluorescent wheel) produced by forming an annular phosphor layer on top of an annular, rotatable transparent substrate.

In order to improve the luminous efficiency of a wavelength conversion member, it is effective to increase the efficiency of incidence of excitation light or the efficiency of emission of fluorescence. To this end, an incident surface or an exit surface of the wavelength conversion member may be coated with an antireflection function layer. For example, Patent Literature 1 discloses a wavelength conversion member in which a low-refractive index layer is formed on a surface of the phosphor layer. Furthermore, Patent Literature 2 discloses a wavelength conversion member in which a surface of a phosphor layer is coated with an antireflection film made of a dielectric film.

### CITATION LIST

### Patent Literature

### [PTL 1]

### JP-A-2014-31488

### [PTL 2]

### JP-A-2013-130605

### SUMMARY OF INVENTION

### Technical Problem

For example, a laser light source for use in a laser projector is used by collecting light beams emitted from a large number of laser elements with a collimating lens, a condenser lens or the like and focusing the light down to a 1 to 2 mm spot size. Since in this manner light beams emitted from a large number of laser elements are collected, the incident angle of excitation light on the wavelength conversion member tends to be large. Furthermore, light converted from the excitation light to fluorescence in the wavelength conversion member is radiated into all directions. Therefore, the light may have a large emission angle on the surface of the wavelength conversion member.

In these cases, in the low-refractive index layer of the wavelength conversion member described in Patent Literature 1, total reflection caused by exceedance of the critical angle may decrease the incidence efficiency of excitation light or the emission efficiency of fluorescence.

On the other hand, the dielectric film of the wavelength conversion member described in Patent Literature 2 exhibits an antireflection function using the cancelling principle due to light interference. But because the antireflection function of the dielectric film depends on the film thickness, an angle of incidence or emission of light equal to or greater than a designed angle leads to an increased apparent film thickness of the dielectric film, which causes a problem that the antireflection function becomes difficult to exhibit.

In view of the foregoing, the present invention has an object of providing a wavelength conversion member that can exhibit an antireflection function for incident light and emitted light at various angles and can increase the luminous efficiency.

### Solution to Problem

The inventors conducted intensive studies and, as a result, found that the above problems can be solved by a wavelength conversion member including a phosphor layer on a surface of which a low-refractive index layer having a particular uneven structure is formed. Specifically, a wavelength conversion member according to the present invention is a wavelength conversion member that includes: a phosphor layer containing a glass matrix and phosphor particles dispersed in the glass matrix; and a low-refractive index layer formed on a surface of the phosphor layer and having a refractive index equal to or smaller than a refractive index of the phosphor particles, wherein the low-refractive index layer has an uneven surface structure and a waviness profile formed by the uneven surface structure has a root-mean-square gradient WΔq of 0.1 to 1.

In the wavelength conversion member according to the present invention, the low-refractive index layer is preferably formed along the phosphor particles projecting from a surface of the glass matrix of the phosphor layer to form the uneven surface structure.

In the wavelength conversion member according to the present invention, the low-refractive index layer preferably has an arithmetic mean roughness of 3 μm or less. By doing so, reduction in luminous efficiency due to light scattering at the surface of the low-refractive index layer can be reduced.

In the wavelength conversion member according to the present invention, the low-refractive index layer is preferably made of glass.

In the wavelength conversion member according to the present invention, a percentage of an area of the phosphor particles exposed on a surface of the low-refractive index layer is preferably 15% or less. By doing so, the low-refractive index layer becomes likely to exhibit an antireflection function.

In the wavelength conversion member according to the present invention, the phosphor particles preferably have an average particle diameter of 10 μm or more. By doing so, a low-refractive index layer having a desired uneven surface structure can be easily obtained.

In the wavelength conversion member according to the present invention, the low-refractive index layer preferably has a thickness of 0.1 mm or less. By doing so, a low-refractive index layer having a desired uneven surface structure can be easily obtained.

In the wavelength conversion member according to the present invention, a content of the phosphor particles in the phosphor layer is preferably 40 to 80% by volume.

In the wavelength conversion member according to the present invention, a difference in coefficient of thermal expansion between the phosphor layer and the low-refractive index layer is preferably 60×10⁻⁷/° C. or less. By doing so, the adhesion strength between the phosphor layer and the low-refractive index layer can be increased.

In the wavelength conversion member according to the present invention, the low-refractive index layers may be formed on both surfaces of the phosphor layer.

In the wavelength conversion member according to the present invention, the phosphor layer preferably has a porosity of 20% or less in a range 20 μm deep from the surface of the phosphor layer. By doing so, light scattering at the surface layer of the phosphor layer can be reduced to increase the efficiency of incidence and emission of light, so that the luminous efficiency of the wavelength conversion member can be further improved.

In the wavelength conversion member according to the present invention, a dielectric film is preferably formed on a surface of the low-refractive index layer. By doing so, the antireflection function is further increased, so that the luminous efficiency of the wavelength conversion member can be further improved.

The wavelength conversion member according to the present invention is suitable for a projector.

A light-emitting device according to the present invention includes: the above-described wavelength conversion member; and a light source capable of irradiating the wavelength conversion member with light having an excitation wavelength for the phosphor particles.

A method for manufacturing a wavelength conversion member according to the present invention is a method for manufacturing the above-described wavelength conversion member and includes the steps of: preparing a green sheet for a phosphor layer containing glass powder and phosphor particles; preparing a green sheet for a low-refractive index layer containing glass powder; and firing both the green sheets with the green sheet for a low-refractive index layer laid on top of the green sheet for a phosphor layer, wherein in the firing step heat is applied at such a temperature that the glass powder used in the green sheet for a low-refractive index layer reaches a viscosity of 10⁷ dPa·s or less.

### Advantageous Effects of Invention

The present invention enables provision of a wavelength conversion member that can exhibit an antireflection function for incident light and emitted light at various angles and can increase the luminous efficiency.

### BRIEF DESCRIPTION OF DRAWINGS

FIG. 1 is a cross-sectional view showing a wavelength conversion member according to a first embodiment of the present invention.

FIG. 2 is a schematic conceptual diagram showing an uneven surface structure formed by a low-refractive index layer and a waviness profile of the uneven surface structure.

FIG. 3 is a schematic cross-sectional view showing a wavelength conversion member according to a second embodiment of the present invention.

FIG. 4 is a cross-sectional view showing a light-emitting device in which the wavelength conversion member according to the first embodiment of the present invention is used.

FIG. 5 is a graph showing the fluorescence intensities of wavelength conversion members in Examples 1 and 3 when the incident angle of excitation light is varied.

FIG. 6 is a graph showing the reflected excitation light intensities of the wavelength conversion members in Examples 1 and 3 when the incident angle of excitation light is varied.

### DESCRIPTION OF EMBODIMENTS

Hereinafter, embodiments of a wavelength conversion member according to the present invention will be described with reference to the drawings.

### (1) Wavelength Conversion Member According to First Embodiment

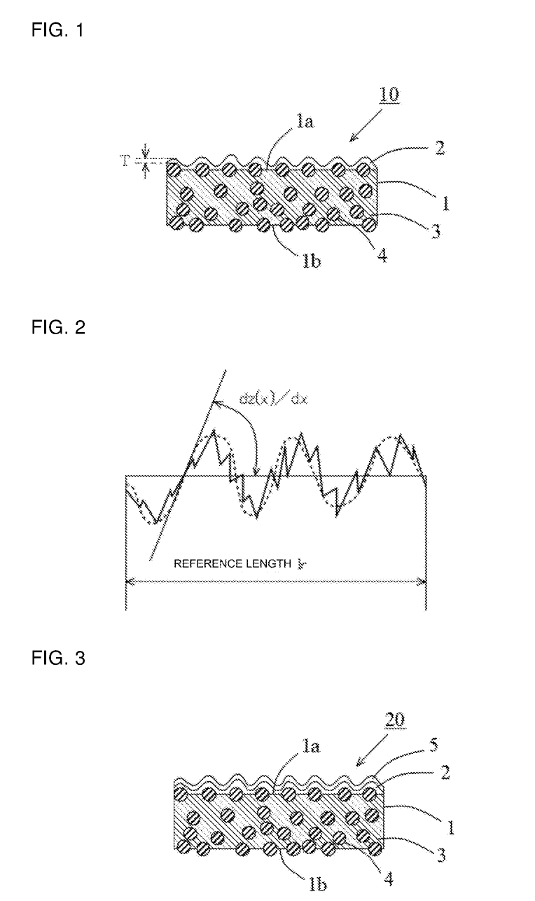

FIG. 1 is a schematic cross-sectional view showing a wavelength conversion member according to a first embodiment of the present invention. A wavelength conversion member 10 includes a phosphor layer 1 and a low-refractive index layer 2 formed on a principal surface 1a of the phosphor layer 1. The phosphor layer 1 contains a glass matrix 3 and phosphor particles 4 dispersed in the glass matrix 3. In the principal surface 1a of the phosphor layer 1, phosphor particles 4 projects from the surface of the glass matrix 3. The low-refractive index layer 2 having an approximately uniform thickness is formed along the projecting phosphor particles 4, so that the low-refractive index layer 2 forms an uneven surface structure.

A detailed description will be given below of each of the components.

(Phosphor Layer 1)

No particular limitation is placed on the type of the glass matrix 3 so long as it is suitable as a dispersion medium for the phosphor particles 4. The glass matrix 3 can be made of, for example, a borosilicate-based glass or a phosphate-based glass, such as a SnO—P₂O₅-based glass. Examples of the borosilicate-based glass include those containing, in % by mass, 30 to 85% SiO₂, 0 to 30% Al₂O₃, 0 to 50% B₂O₃, 0 to 10% Li₂O+Na₂O+K₂O, and 0 to 50% MgO+CaO+SrO+BaO.

The softening point of the glass matrix 3 is preferably 250° C. to 1000° C. and more preferably 300° C. to 850° C. If the softening point of the glass matrix 3 is too low, the mechanical strength and chemical durability of the phosphor layer becomes likely to decrease. Furthermore, because of low thermal resistance of the glass matrix itself, the glass matrix may be softened and deformed by heat produced from the phosphor particles 4. On the other hand, if the softening point of the glass matrix 3 is too high, the phosphor particles 4 may degrade in the firing step during production, so that the luminescence intensity of the wavelength conversion member 10 may decrease.

No particular limitation is placed on the refractive index of the glass matrix 3, but it is normally preferably 1.40 to 1.90 and particularly preferably 1.45 to 1.85. The refractive index used herein refers to the refractive index (nd) at the d-line (light having a wavelength of 587.6 nm), unless otherwise specified.

The phosphor particles 4 may be those containing one or more inorganic phosphors selected from the group consisting of, for example, oxide phosphor, nitride phosphor, oxynitride phosphor, chloride phosphor, oxychloride phosphor, sulfide phosphor, oxysulfide phosphor, halide phosphor, chalcogenide phosphor, aluminate phosphor, halophosphoric acid chloride phosphor, and garnet-based compound phosphor. Specific examples of the phosphor particles 4 are cited below.

Examples of phosphor particles that produce blue fluorescence upon irradiation with ultraviolet to near-ultraviolet excitation light having a wavelength of 300 nm to 440 nm include Sr₅(PO₄)₃Cl:Eu²⁺ and (Sr, Ba) MgAl₁₀O₁₇:Eu²⁺.

Examples of phosphor particles that produce green fluorescence (fluorescence having a wavelength of 500 nm to 540 nm) upon irradiation with ultraviolet to near-ultraviolet excitation light having a wavelength of 300 nm to 440 nm include SrAl₂O₄:Eu²⁺ and SrGa₂S₄:Eu²⁺.

Examples of phosphor particles that produce green fluorescence (fluorescence having a wavelength of 500 nm to 540 nm) upon irradiation with blue excitation light having a wavelength of 440 nm to 480 nm include SrAl₂O₄:Eu²⁺ and SrGa₂S₄:Eu²⁺.

An example of phosphor particles that produce yellow fluorescence (fluorescence having a wavelength of 540 nm to 595 nm) upon irradiation with ultraviolet to near-ultraviolet excitation light having a wavelength of 300 nm to 440 nm is ZnS:Eu²⁺.

Examples of phosphor particles that produce yellow fluorescence (fluorescence having a wavelength of 540 nm to 595 nm) upon irradiation with blue excitation light having a wavelength of 440 nm to 480 nm include Y₃(Al, Gd)₅O₁₂:Ce²⁺, Lu₃Al₅O₁₂:Ce²⁺, Tb₃Al₅O₁₂:Ce²⁺, La₃Si₆N₁₁:Ce, Ca (Si, Al)₁₂(O, N)₁₆:Eu²⁺, (Si, Al)₃(O, N)₄:Eu²⁺, and (Sr, Ba)₂SiO₄:Eu²⁺.

Examples of phosphor particles that produce red fluorescence (fluorescence having a wavelength of 600 nm to 700 nm) upon irradiation with ultraviolet to near-ultraviolet excitation light having a wavelength of 300 nm to 440 nm include Gd₃Ga₄O₁₂:Cr³⁺ and CaGa₂S₄:Mn²⁺.

Examples of phosphor particles that produce red fluorescence (fluorescence having a wavelength of 600 nm to 700 nm) upon irradiation with blue excitation light having a wavelength of 440 nm to 480 nm include Mg₂TiO₄:Mn⁴⁺, K₂SiF₆:Mn⁴⁺, (Ca, Sr)₂Si₅N₈:Eu²⁺, CaAlSiN₃:Eu²⁺, (Sr, Ba)₂SiO₄:Eu²⁺, and (Sr, Ca, Ba)₂SiO₄:Eu²⁺.

If the average particle diameter of the phosphor particles 4 is too small, the projection height (or the amount of exposure) of phosphor particles 4 on the surface of the glass matrix 3 of the phosphor layer 1 becomes small, so that a desired uneven surface structure may not be created upon formation of the low-refractive index layer 2. Therefore, the average particle diameter of the phosphor particles 4 is preferably 10 μm or more and particularly preferably 15 μm or more. However, if the average particle diameter of the phosphor particles 4 is too large, the percentage of phosphor particles 4 exposed on the surface of the low-refractive index layer 2 may become high, in which case the antireflection function of the low-refractive index layer 2 becomes less likely to be exerted. Therefore, the average particle diameter of the phosphor particles 4 preferably not more than 50 μm and particularly preferably not more than 30 μm.

The projection height of phosphor particles 4 on the surface of the glass matrix 3 of the phosphor layer 1 is preferably 1 to 40 μm, more preferably 3 to 30 μm, still more preferably 5 to 25 μm, and particularly preferably 10 to 20 μm. If the projection height of phosphor particles 4 is too small, a desired uneven surface structure may not be created upon formation of the low-refractive index layer 2. On the other hand, if the projection height of phosphor particles 4 is too large, the percentage of phosphor particles 4 exposed on the surface of the low-refractive index layer 2 may become high, in which case the antireflection function of the low-refractive index layer 2 becomes less likely to be exerted.

As used herein, the average particle diameter refers to the particle diameter (D₅₀) when in a volume-based cumulative particle size distribution curve as determined by laser diffractometry the integrated value of cumulative volume from the smaller particle diameter is 50%.

The refractive index of the phosphor particles 4 is normally preferably 1.45 to 1.95 and more preferably 1.55 to 1.90.

Some of the phosphor particles 4 may be exposed on the surface of the low-refractive index layer 2. However, from the viewpoint of obtaining higher-intensity fluorescence, the percentage of the area of phosphor particles 4 exposed on the surface of the low-refractive index layer 2 is preferably 15% or less, more preferably 10% or less, and particularly preferably 8% or less. If the percentage of the area of exposed phosphor particles is too high, the antireflection function of the low-refractive index layer 2 becomes less likely to be exerted. Furthermore, as will be described later, when a dielectric film is formed on the surface of the low-refractive index layer 2, the antireflection function of the dielectric film also becomes less likely to be sufficiently exerted.

The content of the phosphor particles 4 in the phosphor layer 1 is preferably not less than 40% by volume and particularly preferably not less than 45% by volume. If the content of the phosphor particles 4 is too small, the phosphor particles 4 are buried in the glass matrix 3 and do not sufficiently project from the surface of the glass matrix 3. As a result, a desired uneven surface structure may not be created upon formation of the low-refractive index layer 2. Furthermore, a desired fluorescence intensity becomes less likely to be achieved. On the other hand, the content of the phosphor particles 4 in the phosphor layer 1 is preferably not more than 80% by volume and particularly preferably not more than 75% by volume. If the content of the phosphor particles 4 is too large, a lot of voids are formed in the phosphor layer 1, so that the components of the low-refractive index layer 2 becomes likely to permeate the phosphor layer 1 and the percentage of the area of phosphor particles 1 exposed on the surface of the low-refractive index layer 2 tends to be high. Furthermore, the mechanical strength of the phosphor layer 1 becomes likely to decrease. There is no particular problem unless the components of the low-refractive index layer 2 excessively permeate the phosphor layer 1. Instead, if the components of the low-refractive index layer 2 moderately permeate the phosphor layer 1, the porosity in the surface layer of the phosphor layer 1 becomes low, so that light scattering at the surface layer of the phosphor layer 1 is reduced. As a result, the efficiency of incidence and emission of light on and from the wavelength conversion member 10 may increase, so that the luminous efficiency of the wavelength conversion member 10 may be able to be improved. The porosity in a range 20 μm deep from the surface of the phosphor layer 1 (the interface between the phosphor layer 1 and the low-refractive index layer 2) is preferably 20% or less, more preferably 15% or less, and particularly preferably 10% or less.

The thickness of the phosphor layer 1 needs to be such that excitation light can be surely absorbed into the phosphor particles 4, but is preferably as small as possible. The reason for this is that if the phosphor layer 1 is too thick, scattering and absorption of light in the phosphor layer 1 may become too much, so that the efficiency of emission of fluorescence may become low. Specifically, the thickness of the phosphor layer 1 is preferably not more than 0.5 mm, more preferably not more than 0.3 mm, and particularly preferably not more than 0.2 mm. However, if the thickness of the phosphor layer 1 is too small, the content of the phosphor particles 4 becomes low, so that a desired fluorescence intensity becomes less likely to be achieved. Furthermore, the mechanical strength of the phosphor layer 1 may decrease. Therefore, the thickness of the phosphor layer 1 is preferably not less than 0.03 mm.

The shape of the phosphor layer 1 can be appropriately selected according to the intended use. The shape of the phosphor layer 1 is, for example, a rectangular plate shape, a disc shape, a wheel plate shape or a sector plate shape.

(Low-Refractive Index Layer 2)

The low-refractive index layer 2 is made of, for example, glass or resin. Glasses that can be used are the same as cited as examples for the glass matrix 3 of the phosphor layer 1.

The low-refractive index layer 2 has a refractive index lower than the phosphor particles 4 and thus serves as an antireflection function layer. The refractive index of the low-refractive index layer 2 is, for example, preferably 1.45 to 1.95, more preferably 1.40 to 1.90, and particularly preferably 1.45 to 1.85.

Furthermore, the difference in refractive index between the glass matrix 3 of the phosphor layer 1 and the low-refractive index layer 2 is preferably 0.1 or less, more preferably 0.08 or less, and particularly preferably 0.05 or less. If this difference in refractive index is large, reflection at the interface between the glass matrix 3 of the phosphor layer 1 and the low-refractive index layer 2 becomes large, so that the luminous efficiency becomes likely to decrease.

The low-refractive index layer 2 is preferably substantially free of phosphor particles and of additives having higher refractive indices than the glass matrix 3. In other words, the low-refractive index layer 2 is preferably made substantially only of glass (or resin). By doing so, a desired antireflection function becomes likely to be exerted.

If the thickness of the low-refractive index layer 2 is large, a low-refractive index layer having a desired uneven surface structure becomes less likely to be obtained. Furthermore, excitation light and fluorescence become likely to be absorbed and the content of phosphor particles 4 in the total amount of the wavelength conversion member 10 becomes relatively small. As a result, the luminous efficiency of the wavelength conversion member 10 becomes likely to decrease. Therefore, the thickness of the low-refractive index layer 2 is preferably not more than 0.1 mm, more preferably not more than 0.05 mm, still more preferably not more than 0.03 mm, and particularly preferably not more than 0.02 mm. If the thickness of the low-refractive index layer 2 is too small, the percentage of the area of phosphor particles 4 exposed on the surface of the low-refractive index layer 2 tends to be large. Therefore, the thickness thereof is preferably not less than 0.003 mm and particularly preferably not less than 0.01 mm. Note that the thickness of the low-refractive index layer 2 refers to the distance T between the top of the uneven surface structure and the phosphor particles 4.

From the viewpoint of making excitation light and fluorescence less likely to be absorbed in the low-refractive index layer 2, the low-refractive index layer 2 preferably has a total light transmittance of preferably 50% or more, more preferably 65% or more, and particularly preferably 80% or more in a visible light range (of wavelengths from 400 to 800 nm).

The low-refractive index layer 2 is preferably fusion-bonded to the phosphor layer 1. By doing so, light reflection and scattering at the interface between the phosphor layer 1 and the low-refractive index layer 2 can be reduced, so that the luminous efficiency can be improved.

From the viewpoint of increasing the adhesion strength between the phosphor layer 1 and the low-refractive index layer 2, the difference in coefficient of thermal expansion between them is preferably 60×10⁻⁷/° C. or less, more preferably 50×10⁻⁷/° C. or less, still more preferably 40×10⁻⁷/° C. or less, and particularly preferably 30×10⁻⁷/° C. or less.

The root-mean-square gradient WΔq of the waviness profile (profile) of the uneven surface structure formed by the low-refractive index layer 2 is preferably 0.1 to 1, more preferably 0.2 to 0.8, and particularly preferably 0.3 to 0.7. The root-mean-square gradient WΔq of the waviness profile is a parameter determined by averaging the gradients of the waviness profile in a particular range and can be determined in conformity to JIS-B0601-2001. Specifically, the root-mean-square gradient WΔq of a waviness profile is represented by the following equation (see FIG. 2, wherein the solid curve represents a low-refractive index layer, the dotted curve represents the waviness profile of the low-refractive index layer, and “dz(x)/dx” represents a gradient of the waviness profile).

$$W Δ q = \sqrt{\frac{1}{Ir} {\int }_{O}^{Ir} {( dz ( x ) / dx )}^{2}} \qquad [ Math . 1 ]$$

The above root-mean-square gradient WΔq serves as an index of the angle of gradient of the uneven surface structure formed by the low-refractive index layer 2. If the value of the above root-mean-square gradient WΔq is in the above range, the antireflection function can be exhibited for incident light and emitted light at various angles. Note that a root-mean-square gradient WΔq of 0.1 of a waviness profile corresponds to an average gradient of 5° of a waviness surface and a root-mean-square gradient WΔq of 1 of a waviness profile corresponds to an average gradient of 45° of a waviness surface.

If the value of the root-mean-square gradient WΔq is too small, the angle of gradient of the uneven surface structure formed by the low-refractive index layer 2 (the angle of gradient thereof with respect to the principal surface 1a of the phosphor layer 1) becomes small. As a result, among excitation light incident on the low-refractive index layer 2 and fluorescence emitted from the phosphor layer 1 toward the low-refractive index layer 2, their light components having large angles of incidence and emission become likely to be reflected at the surfaces of the low-refractive index layer 2, so that the luminous efficiency becomes likely to decrease.

On the other hand, if the value of the root-mean-square gradient WΔq is too large, the angle of gradient of the uneven surface structure formed by the low-refractive index layer 2 becomes large. As a result, among excitation light incident on the low-refractive index layer 2 and fluorescence emitted from the phosphor layer 1 toward the low-refractive index layer 2, their light components having small angles of incidence and emission become likely to be reflected at the surfaces of the low-refractive index layer 2, so that the luminous efficiency becomes likely to decrease.

The arithmetic mean roughness (Ra) of the low-refractive index layer 2 is preferably 3 μm or less, more preferably 2 μm or less, still more preferably 1 μm or less, and particularly preferably 0.5 μm or less. If the arithmetic mean roughness of the low-refractive index layer 2 is too large, light scattering at the surface of the low-refractive index layer 2 becomes large, so that the luminous efficiency of the wavelength conversion member 10 becomes likely to decrease. Furthermore, a dielectric film to be described hereinafter becomes less likely to be formed on the surface of the low-refractive index layer 2.

Low-refractive index layers 2 may be formed on both the principal surface 1a and principal surface 1b of the phosphor layer 1. By doing so, when the wavelength conversion member 10 is used as a transmissive wavelength conversion member, the efficiency of incidence of excitation light on the phosphor layer 1 can be increased and the efficiency of emission of fluorescence from the phosphor layer 1 can be increased.

Alternatively, a reflective member (not shown) may be placed on the principal surface 1b of the phosphor layer 1 and, thus, the wavelength conversion member may be used as a reflective wavelength conversion member. In this case, excitation light enters the phosphor layer 1 through the principal surface 1a and fluorescence emitted from the phosphor particles 4 is reflected by the reflective member and goes out of the phosphor layer 1 through the principal surface 1a.

### (2) Wavelength Conversion Member According to Second Embodiment

FIG. 3 is a schematic cross-sectional view showing a wavelength conversion member according to a second embodiment of the present invention. In a wavelength conversion member 20 according to this embodiment, a dielectric film 5 serving as an antireflection function layer is formed on the surface of the low-refractive index layer 2. The other structures are the same as in the wavelength conversion member 10 according to the first embodiment. Since the dielectric film 5 is formed on the surface of the low-refractive index layer 2, the antireflection function is further increased, so that the luminous efficiency of the wavelength conversion member 10 can be further improved. The dielectric film 5 becomes likely to exhibit a desired antireflection function, not when formed directly on the surface of the phosphor layer 1, but when formed thereon via the low-refractive index layer 2. The reason for this is can be explained as follows.

In the phosphor layer 1, generally, the glass matrix 3 has a low refractive index than the phosphor particles 4. Therefore, if no low-refractive index layer 2 is formed, there are low-refractive index regions and high-refractive index regions on the principal surface 1a of the phosphor layer 10. A dielectric film needs to be optically designed to meet the refractive index of a member on which the film is to be formed. If a dielectric film optically designed to meet the low-refractive index regions is formed, the dielectric film is less likely to exhibit a desired antireflection function for the high-refractive index regions. On the other hand, if a dielectric film optically designed to meet the high-refractive index regions is formed, the dielectric film is less likely to exhibit a desired antireflection function for the low-refractive index regions. If, in view of this, a low-refractive index layer 2 is formed on the surface of the phosphor layer 1, the refractive index of the member on which the dielectric film is to be formed is uniform. Therefore, the dielectric film is optically designed to meet the refractive index of the low-refractive index layer 2, so that a desired antireflection function can be exhibited.

As described previously, if the angle of incidence and emission of light on and from the dielectric film is large, the dielectric film is less likely to exhibit a desired antireflection function. To cope with this, in this embodiment, the dielectric film 5 is formed along the surface of the low-refractive index layer 2 having an uneven surface structure. In other words, the dielectric film 5 has an uneven surface structure. Therefore, even for light having large angles of incidence and emission on and from the surface of the phosphor layer 1, predetermined inclined surfaces that the dielectric film 5 partially has can reduce the angles of incidence and emission of the light on and from the dielectric film 5. As a result, the antireflection function of the dielectric film 5 can be exhibited.

The dielectric film 5 is designed in terms of material, number of layers, and thickness so that the reflectance can be reduced in a visible light range. Examples of the material for the dielectric film 5 include SiO₂, Al₂O₃, TiO₂, Nb₂O₅, and Ta₂O₅. The dielectric film 5 may be a single-layer film or a multi-layer film.

### (3) Method for Manufacturing Wavelength Conversion Member

Hereinafter, a description will be given of an example of a method for manufacturing the wavelength conversion member 10 according to the first embodiment.

First, a green sheet for a phosphor layer 1 is prepared which contains glass powder for forming a glass matrix 3 and phosphor particles 4. Specifically, a slurry containing glass powder, phosphor particles 4, and organic components, including a binder resin, a solvent, and a plasticizer, is applied onto a resin film made of polyethylene terephthalate or other materials by the doctor blade method or other methods and then dried by the application of heat, thus producing a green sheet for a phosphor layer 1. Furthermore, a green sheet for a low-refractive index layer 2 containing glass powder is prepared in the same manner as above.

Next, the green sheet for a low-refractive index layer 2 is laid on top of the green sheet for a phosphor layer 1, bonded together by pressure if necessary, and then fired. The firing is performed by the application of heat to such a temperature that the glass powder used in the green sheet for a low-refractive index layer 2 reaches a viscosity of 10⁷ dPa·s or less, preferably 10^{6.5} Pa·s or less, and more preferably 10⁶ Pa·s or less. By doing so, the fluidization of the glass powder can be promoted, which enables easy formation of a low-refractive index layer 2 having a desired uneven surface structure along the phosphor particles 3 projecting on the surface of the glass matrix 3 of the phosphor layer 1. Furthermore, the surface of the low-refractive index layer 2 becomes smooth and the arithmetic mean roughness can be reduced. However, if the firing temperature is too high, the glass powder excessively flows, so that the percentage of the area of phosphor particles 4 exposed on the surface of the low-refractive index layer 2 may become too large. Therefore, the firing temperature is preferably such a temperature that the glass powder used in the green sheet for a low-refractive index layer 2 reaches a viscosity of preferably not less than 10⁴ Pa·s and particularly preferably not less than 10⁵ Pa·s.

Other than the above method, a wavelength conversion member 1 may be produced by first firing only the green sheet for a phosphor layer 1 to prepare a phosphor layer 1, then laying the green sheet for a low-refractive index layer 2 on a surface of the phosphor layer 1, bonding them together by the application of heat and pressure, and firing them. Alternatively, the low-refractive index layer 2 may be formed on the surface of the phosphor layer 1 using the sol-gel method.

Still alternatively, a wavelength conversion member 1 may be produced by preparing a thin sheet glass for forming a low-refractive index layer 2, laying the green sheet for a phosphor layer 1 on a surface of the thin sheet glass, bonding them together by the application of heat and pressure, and firing the green sheet to form a phosphor layer 1.

Note that a wavelength conversion member 20 according to the second embodiment can be produced by forming a dielectric layer 5 on the surface of the low-refractive index layer 2. The dielectric layer 5 can be formed by a known method, such as vacuum deposition, ion plating, ion assisted deposition or sputtering.

### (4) Light-Emitting Device

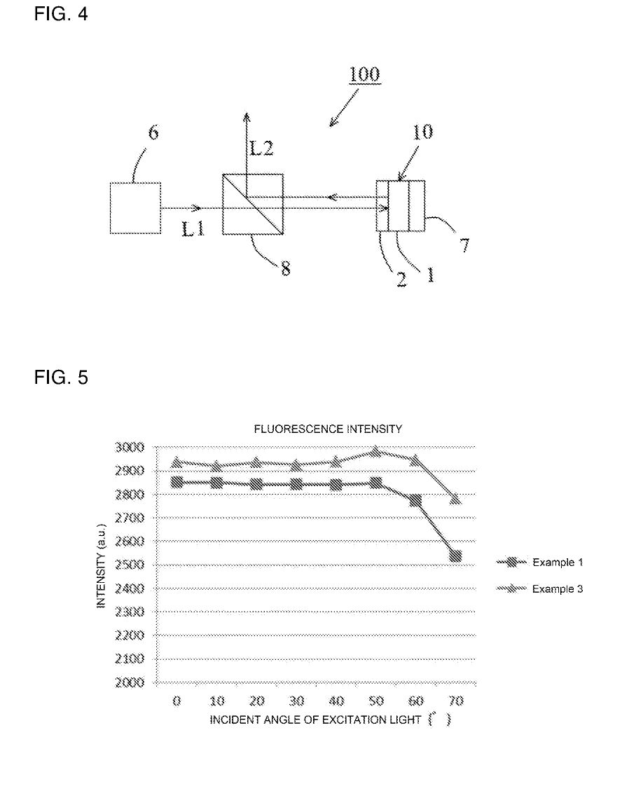

FIG. 4 shows a schematic view of a light-emitting device 100 in which the wavelength conversion member 10 is used. The light-emitting device 100 includes a light source 6 and the wavelength conversion member 10. The light source 6 emits light L1 having an excitation wavelength for the phosphor particles 4 contained in the phosphor layer 1. When the light L1 enters the phosphor layer 1, the phosphor particles 4 absorb the light L1 and emits fluorescence L2. A reflective member 7 is placed on the opposite side of the wavelength conversion member 10 facing to the light source 6 and, therefore, the fluorescence L2 is emitted toward the side facing to the light source 6. The fluorescence L2 is reflected by a beam splitter 8 interposed between the light source 6 and the wavelength conversion member 10 and thus extracted from the light-emitting device 100 to the outside.

### EXAMPLES

The present invention will be described below in further detail with reference to specific examples. However, the present invention is not at all limited to the following examples and modifications and variations may be appropriately made therein without changing the gist of the invention.

Table 1 shows Examples 1 to 4 and Comparative Examples 1 and 2.

TABLE 1

| Example | | | | Comparative Example | | |
|---|---|---|---|---|---|---|
| 1 | 2 | 3 | 4 | 1 | 2 | 3 |

| | | | | |
|---|---|---|---|---|
| Phosphor Layer | Glass matrix | Refractive index | 1.49 | 1.49 |
| | Inorganic phosphor particles | Type of phosphor | YAG | YAG |
| | | Average particle diameter (μm) | 23 | 23 |
| | | Content (% by volume) | 70 | 70 |

| | Thickness (mm) | 0.12 | | | | 0.12 | | |
|---|---|---|---|---|---|---|---|---|
| | Coefficient of thermal expansion (×10⁻⁷/° C.) | 79 | | | | 79 | | |
| Low-Refractive | Refractive index | 1.49 | 1.46 | 1.49 | 1.46 | 1.46 | 1.46 | — |
| Index Layer | Thickness (mm) | 0.01 | 0.03 | 0.01 | 0.03 | 0.15 | 0.04 | — |
| | Root-mean-square gradient WAq of waviness profile | 0.38 | 0.15 | 0.38 | 0.15 | 0.08 | 0 | — |
| | Arithmetic surface roughness Ra (μm) | 0.19 | 0.48 | 0.19 | 0.48 | 0.12 | 0.01 | — |
| | Coefficient of thermal expansion (×10⁻⁷/° C.) | 51 | 23 | 51 | 23 | 51 | 51 | — |

| | | | | | | | |
|---|---|---|---|---|---|---|---|
| Percentage of area of phosphor particles exposed (%) | 2 | 1 | 2 | 1 | 0 | 0 | 100 |
| Difference in coefficient of thermal expansion between phosphor layer and low- | 28 | 56 | 28 | 56 | 28 | 28 | — |
| refractive index layer (×10⁻⁷/° C.) | | | | | | | |
| Porosity in range 20 μm deep from phosphor layer surface (%) | 9 | 6 | 8 | 5 | 7 | 10 | 32 |
| Viscosity during firing of glass powder used in green sheet for low-refractive index | 10^{5.8} | 10^{6.2} | 10^{5.8} | 10^{6.2} | 10^{5.8} | 10^{5.8} | 10^{5.8} |
| layer (Pa · s) | | | | | | | |
| Dielectric multi-layer film | not | not | formed | formed | not | not | not |
| | formed | formed | | | formed | formed | formed |
| Fluorescence intensity (a.u.) | 105 | 100 | 110 | 108 | 92 | 72 | 59 |

### Example 1

(a) Production of Green Sheet for Phosphor Layer

Raw materials were compounded to provide a composition of 71% SiO₂, 6% Al₂O₃, 13% B₂O₃, 1% K₂O, 7% Na₂O, 1% CaO, and 1% BaO and subjected to a melt-quenching process, thus producing a film-like glass. The obtained film-like glass was wet ground using a ball mill to obtain glass powder (softening point: 775° C.) having an average particle diameter of 2 μm.

The obtained glass powder and YAG phosphor particles (YAG phosphor powder) (yttrium aluminum garnet: Y₃Al₅O₁₂) having an average particle diameter of 23 μm were mixed using a vibrational mixer to give a ratio of glass powder to YAG phosphor particles of 30% by volume to 70% by volume. Organic components, including a binder, a plasticizer, and a solvent, were added in appropriate amounts to 50 g of the obtained mixed powder and the mixture was kneaded in a ball mill for 12 hours, thus obtaining a slurry. The slurry was applied onto a PET (polyethylene terephthalate) film using the doctor blade method and dried, thus obtaining a 0.15 mm thick green sheet for a phosphor layer.

(b) Production of Green Sheet for Low-Refractive Index Layer

Using 50 g of glass powder obtained in (a), a slurry was obtained in the same manner as described above. The slurry was applied onto a PET film using the doctor blade method and dried, thus obtaining a 0.025 mm thick green sheet for a low-refractive index layer.

(c) Production of Wavelength Conversion Member

Each of the green sheets produced in the above manners was cut into a piece having a size of 30 mm by 30 mm, these cut pieces were laid one on top of another, and, in this state, a pressure of 15 kPa was applied to them at 90° C. for one minute using a thermocompression bonder, thus producing a laminate. The laminate was cut into a circular piece with a diameter of 25 mm and the circular piece was then subjected to a degreasing treatment at 600° C. for an hour in the atmosphere, and then fired at 800° C. for an hour, thus producing a wavelength conversion member. In the obtained wavelength conversion member, the thickness of the phosphor layer was 0.12 mm and the thickness of the low-refractive index layer (glass layer) was 0.01 mm.

The properties were measured in the following manners.

The softening point was measured using a differential thermal analyzer (TAS-200 manufactured by Rigaku Corporation).

The coefficient of thermal expansion was measured in a range of 25 to 250° C. using a dilatometer (DILATO manufactured by Mac Science Corporation).

The root-mean-square gradient WΔq of the waviness profile of the uneven surface structure of the low-refractive index layer and the arithmetic mean roughness of the low-refractive index layer were measured using a shape analysis laser microscope VK-X manufactured by Keyence Corporation.

The percentage of the area of phosphor particles exposed on the surface of the low-refractive index layer was calculated based on an image of a top surface taken by a SEM (scanning electron microscope). Furthermore, the porosity in a range 20 μm deep from the surface of the phosphor layer was calculated based on an image of a cross-section taken by a SEM.

The viscosity during firing of the glass powder used in the green sheet for a low-refractive index layer was determined by the fiber elongation method.

### Example 2

(a) Production of Green Sheet for Phosphor Layer

The same green sheet as in Example 1 was used.

(b) Production of Green Sheet for Low-Refractive Index Layer

Raw materials were compounded to provide a composition of 78% SiO₂, 1% Al₂O₃, 19% B₂O₃, 1% K₂O, and 1% MgO and subjected to a melt-quenching process, thus producing a film-like glass. The obtained film-like glass was wet ground with a ball mill to obtain glass powder (softening point: 825° C.) having an average particle diameter of 2 μm.

Using 50 g of the obtained glass powder, a slurry was obtained in the same manner as in Example 1. The slurry was applied onto a PET film using the doctor blade method and dried, thus obtaining a 0.06 mm thick green sheet for a low-refractive index layer.

(c) Production of Wavelength Conversion Member

A wavelength conversion member was produced in the same manner as in Example 1 except that the firing temperature was 850° C. In the obtained wavelength conversion member, the thickness of the phosphor layer was 0.12 mm and the thickness of the low-refractive index layer (glass layer) was 0.03 mm.

### Example 3

A dielectric multi-layer film (film structure: a four-layered structure composed of SiO₂, Al₂O₃, Ta₂O₅, and SiO₄ layers, total film thickness: 500 nm) was formed by sputtering on the surface of the low-refractive index layer of the wavelength conversion member produced in Example 1, thus obtaining a wavelength conversion member.

### Example 4

The same dielectric multi-layer film as in Example 3 was formed by sputtering on the surface of the low-refractive index layer of the wavelength conversion member produced in Example 2, thus obtaining a wavelength conversion member.

### Comparative Example 1

(a) Production of Green Sheet for Phosphor Layer

The same green sheet as in Example 1 was used.

(b) Production of Green Sheet for Low-Refractive Index Layer

Using 50 g of glass powder obtained in (a), a slurry was obtained in the same manner as described above. The slurry was applied onto a PET film using the doctor blade method and dried, thus obtaining a 0.3 mm thick green sheet for a low-refractive index layer.

(c) A wavelength conversion member was produced in the same manner as in Example 1. In the obtained wavelength conversion member, the thickness of the phosphor layer was 0.12 mm and the thickness of the low-refractive index layer (glass layer) was 0.15 mm.

### Comparative Example 2

The low-refractive index layer of the wavelength conversion member obtained in Comparative Example 1 was subject to lapping with alumina abrasive grains and then polished to a mirror finish with cerium oxide abrasive grains, thus obtaining a wavelength conversion member.

### Comparative Example 3

Only the green sheet for a phosphor layer was fired in Example 1, thus obtaining a wavelength conversion member.

(Evaluations)

(a) Evaluation of Fluorescence Intensity

Each wavelength conversion member produced as described above was bonded with an adhesive (silicone resin manufactured by Shin-Etsu Chemical Co., Ltd.) to the central portion of an aluminum reflective substrate (MIRO-SILVER manufactured by Material House Co., Ltd., 30 mm×30 mm), with the phosphor layer side facing the reflective substrate, thus producing a reflection-type measurement sample.

An excitation light source was prepared which can focus emitted light from a laser unit formed of an array of thirty 1 W blue laser elements (wavelength: 440 nm) to a 1 mm diameter spot with a collecting lens. The maximum incident angle of excitation light emitted from this light source with respect on the surface of the measurement sample (the angle when the normal line on the surface of the measurement sample was defined as 0°) was 60°.

The center of the measurement sample was fixed to the shaft of a motor and the surface of the measurement sample was irradiated with excitation light while being rotated at a rotational speed of 7000 RPM. The reflected light was received via an optical fiber by a small spectrometer (USB-4000 manufactured by Ocean Optics Inc.) to obtain luminescence spectra. The fluorescence intensity was determined from the luminescence spectra. The results are shown in Table 1.

As shown in Table 1, in the wavelength conversion members of Examples 1 to 4, the waviness profiles of the surfaces of the low-refractive index layers had root-mean-square gradients WΔq of 0.15 to 0.38 and the fluorescence intensities were 100 to 110 a.u. On the other hand, in the wavelength conversion members of Comparative Examples 1 and 2, the waviness profiles of the surfaces of the low-refractive index layers had root-mean-square gradients WΔq of 0 to 0.08 and the fluorescence intensities were 72 to 92 a.u. Furthermore, in the wavelength conversion member of Comparative Example 3 in which no low-refractive index layer was formed, the fluorescence intensity was 59 a.u. As seen from this, the wavelength conversion members of Examples exhibited higher fluorescence intensities than those of Comparative Examples.

(b) Evaluation of Angle Dependency of Antireflection Function Layer

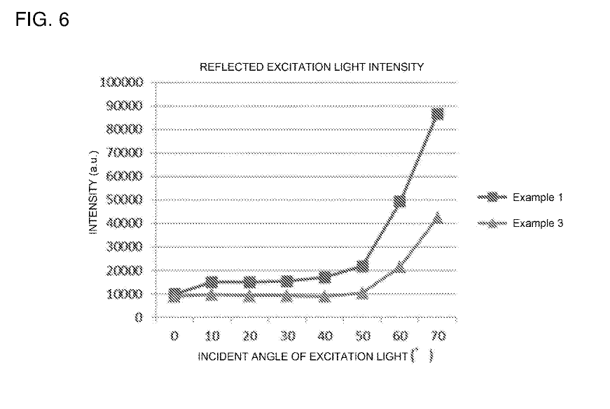

For Examples 1 and 3, the same measurement samples as in (a) were produced. The measurement sample was fixed to the shaft of a motor and irradiated with excitation light while being rotated at a rotational speed of 7000 RPM. A single blue laser element as mentioned above was used as a light source and the incident angle was varied between 0° and 70° at an interval of 10°. The reflected light was received via an optical fiber by a small spectrometer (USB-4000 manufactured by Ocean Optics Inc.) to obtain luminescence spectra. The fluorescence intensity and reflected excitation light intensity was determined from the luminescence spectra. The results are shown in FIGS. 5 and 6.

As shown in FIGS. 5 and 6, it can be seen that the wavelength conversion members of Examples 1 and 3 exhibited good antireflection function for excitation light over a wide range of incident angles approximately from 0° to 50°. Furthermore, it can also be seen that further formation of the dielectric multi-layer film on the surface of the low-refractive index layer improved the antireflection function.

In each of the above evaluations, the values of the light intensities are indicated in an arbitrary unit (a.u.) and do not refer to the absolute values.

### INDUSTRIAL APPLICABILITY

The wavelength conversion member according to the present invention is suitable for a projector. Other than the projector, the wavelength conversion member according to the present invention can also be used for an on-vehicle lighting, such as a headlamp, and other lightings.

### REFERENCE SIGNS LIST

1 . . . phosphor layer
2 . . . low-refractive index layer
3 . . . glass matrix
4 . . . phosphor particle
5 . . . dielectric multi-layer film
6 . . . light source
7 . . . reflective member
8 . . . beam splitter
10, 20 . . . wavelength conversion member
100 . . . light-emitting device

1. A wavelength conversion member comprising:
a phosphor layer containing a glass matrix and phosphor particles dispersed in the glass matrix; and
a low-refractive index layer formed on a surface of the phosphor layer and having a refractive index equal to or smaller than a refractive index of the phosphor particles,
wherein the low-refractive index layer has an uneven surface structure and a waviness profile formed by the uneven surface structure has a root-mean-square gradient WΔq of 0.1 to 1.

2. The wavelength conversion member according to claim 1,
wherein the low-refractive index layer is formed along the phosphor particles projecting from a surface of the glass matrix of the phosphor layer to form the uneven surface structure.

3. The wavelength conversion member according to claim 1, wherein the low-refractive index layer has an arithmetic mean roughness of 3 μm or less.

4. The wavelength conversion member according to claim 1, wherein the low-refractive index layer is made of glass.

5. The wavelength conversion member according to claim 1, wherein a percentage of an area of the phosphor particles exposed on a surface of the low-refractive index layer is 15% or less.

6. The wavelength conversion member according to claim 1, wherein the phosphor particles have an average particle diameter of 10 μm or more.

7. The wavelength conversion member according to claim 1, wherein the low-refractive index layer has a thickness of 0.1 mm or less.

8. The wavelength conversion member according to claim 1, wherein a content of the phosphor particles in the phosphor layer is 40 to 80% by volume.

9. The wavelength conversion member according to claim 1, wherein a difference in coefficient of thermal expansion between the phosphor layer and the low-refractive index layer is 60×10⁻⁷/° C. or less.

10. The wavelength conversion member according to claim 1, wherein the low-refractive index layers are formed on both surfaces of the phosphor layer.

11. The wavelength conversion member according to claim 1, wherein the phosphor layer has a porosity of 20% or less in a range 20 μm deep from the surface of the phosphor layer.

12. The wavelength conversion member according to claim 1, wherein a dielectric film is formed on a surface of the low-refractive index layer.

13. The wavelength conversion member according to claim 1, being for use in a projector.

14. A light-emitting device comprising:
the wavelength conversion member according to claim 1; and
a light source capable of irradiating the wavelength conversion member with light having an excitation wavelength for the phosphor particles.

15. A method for manufacturing the wavelength conversion member according to claim 1, the method comprising the steps of:
preparing a green sheet for a phosphor layer containing glass powder and phosphor particles;
preparing a green sheet for a low-refractive index layer containing glass powder; and
firing both the green sheets with the green sheet for a low-refractive index layer laid on top of the green sheet for a phosphor layer,
wherein in the firing step heat is applied at such a temperature that the glass powder used in the green sheet for a low-refractive index layer reaches a viscosity of 10⁷ dPa·s or less.
